(19) United States
(12) Patent Application Publication
(10) Pub. No.: US 2003/0114556 A1
(43) Pub. Date: Jun. 19, 2003

(54) Casting compound having a high thermal stability

(76) Inventors: Irene Jennrich, Winnenden (DE); Richard Spitz, Reutlingen (DE); Wolfgang Endres, Remshalden (DE)

Correspondence Address: KENYON & KENYON, ONE BROADWAY, NEW YORK, NY, 10004, US

(21) Appl. No.: 10/242,229

(22) Filed: Sep. 12, 2002

(30) Foreign Application Priority Data
Sep. 12, 2001 (DE) 101 44 871.6-43

(51) Int. Cl. C08L 63/00

(52) U.S. Cl. 523/400

(57) ABSTRACT

A casting compound having a high thermal stability is described; as a one-component system, it is stable in storage and contains an epoxy resin component, a filler, and an initiator. The filler contains silanized fused silica.

### FIELD OF THE INVENTION

The present invention relates to a casting compound having a high thermal stability and a method of producing same as well as its use.

### BACKGROUND INFORMATION

Casting compounds based on a resin which cures by chemical reaction play a major role in the production of industrial parts and components. Such casting compounds are usually formulated as two-component systems, one component being a curing agent which is mixed with the other component, containing reactive resins, fillers, etc., and is processed immediately. However, adequate occupational safety in handling the compound as it cures is ensured only at a major expense, because compounds that are irritants or even pose a health hazard, e.g., carboxylic acid anhydrides or amines, are often used as the curing agent. For this reason one-component systems were developed.

German Published Patent Application No. 196 38 630 describes such casting materials for underfilling electric and electronic components which protect against ambient effects and stabilize solder joints in the components. The one-component systems described there are cured thermally and/or by the action of UV radiation.

The object of the present invention is to provide a casting compound which is stable in storage as a one-component system and is processable while additionally having a high thermal stability and resistance to cracking.

### SUMMARY OF THE INVENTION

An object of the present invention is achieved according to the present invention by providing a casting compound which is processable as a one-component system and contains silanized fused silica as a filler. The casting compound has a low viscosity and a good capillary effect during processing and is characterized in the fully cured state by a high elongation at rupture and a low thermal expansion coefficient. It also has an extremely high thermal stability because of the polymer on which it is based.

Thus, the casting compound preferably has a silanizing agent which permits a constant degree of silanization of the fused silica used as the filler.

In a particularly advantageous embodiment, the casting compound contains fused silica having a particle size of 0.5 to 200 μm as the filler, and it is advantageous to use fused silica having a plurality of different particle size distributions. This ensures a high mechanical load-bearing capacity and a low coefficient of expansion of the casting compound in the cured state.

### DETAILED DESCRIPTION

Casting compounds according to the present invention have three basic components, namely an epoxy resin component A, a filler B, and an initiator C. In addition, another silicone-containing component D may also be provided. Furthermore, the casting compounds contain one or more foam suppressants, sedimentation inhibitors and adhesives, use of which is familiar to those skilled in the art.

In general, it should be noted that casting compounds form a stable system before and during processing in order to prevent separation of components. The filler particles should form a stable dispersion with the epoxy resin components, and the epoxy resin components should in turn form stable solutions or emulsions with one another. This stability is ensured during processing as well as curing of the casting compound.

In principle a variety of monomer compounds having at least one epoxy function may be used as epoxy resin component A, either alone or in mixture with other compounds with or without an epoxy function. However, it is particularly advantageous to use diepoxides and/or triepoxides, the commercially available compounds listed below being given as examples:

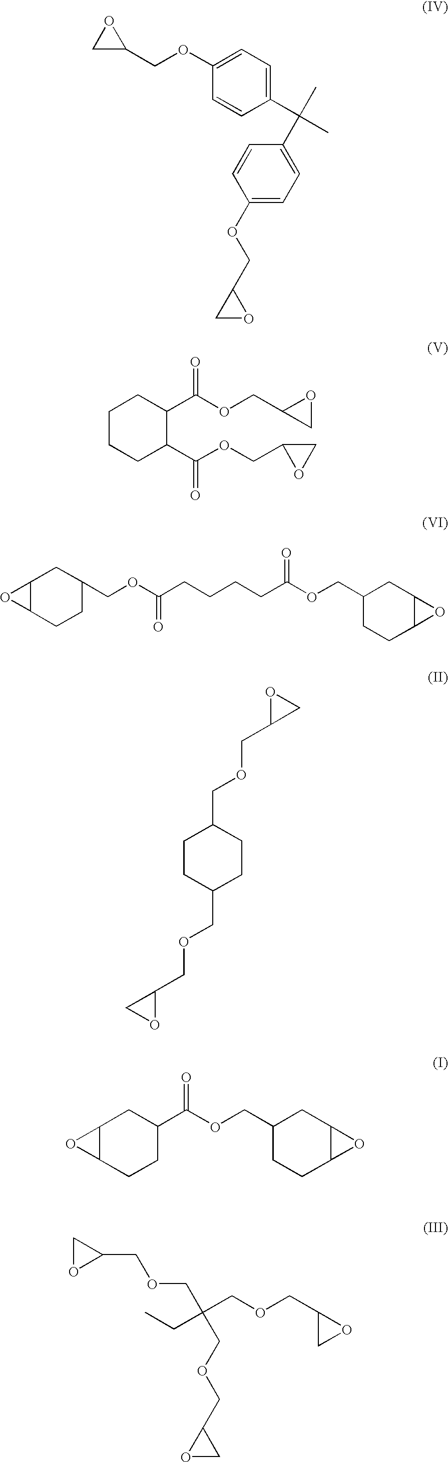

as well as other components. Ring-epoxidized cycloaliphatic diepoxides such as (I) and (VI) have proven to be especially suitable. Epoxy resin component A is present in the casting compound in an amount of 10 wt % to 90 wt %, preferably 32 wt % to 40 wt %.

The casting compound also contains a filler B, a suitable choice of which may prevent shrinkage of the casting compound during processing and adjust the thermal stability and/or resistance to cracking of the casting compound in the cured state. Filler B contains partially or completely silanized fused silica which is used in ground form and has a particle size of 0.5 to 200 μm, for example. Fused silica of several different particle size distributions is preferably used.

The use of silanized fused silica determines the desired properties of the casting compound such as resistance to cracking and thermal stability. Silanizing the fused silica involves surface modification of the fused silica particles and improves the binding of filler B to the matrix of the casting compound. To be able to adjust the degree of silanization of the fused silica in a targeted manner, the fused silica is either first treated with a silanizing agent and the presilanized fused silica is then added to the casting compound or the silanizing agent is added to the casting compound and the actual silanization reaction takes place in the casting compound. In particular, organofunctional trialkoxysilanes and/or epoxysilanes are suitable silanizing agents, e.g., trimethoxy-2,3-epoxypropylsilane (VII) or trimethoxy-3-(2′,3′-epoxypropyloxy)propylsilane (VIII).

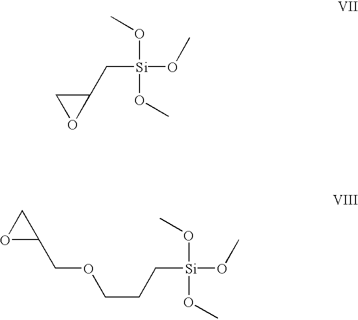

In addition, filler B may also contain unsilanized fused silica, powdered quartz, aluminum oxide, chalk or talc, optionally in mixture with silicon carbide. Filler B is present in the casting compound in an amount of up to 10 wt % to 85 wt %, preferably 55 wt % to 65 wt %.

The casting compound contains as third component C an initiator which permits an adequately rapid reaction to take place at an elevated temperature. Suitable initiators include both thermal initiators and photoinitiators.

To ensure that the casting compound is processable as a one-component system, a cationic crosslinking agent was selected as the initiator. It may be, for example, a quinolinium, iodonium or boron-iodonium compound. These result in cationic polymerization of the epoxy resin.

The initiator may also contain a co-catalyst, which is used in particular to lower the starting temperature of the reaction. It may be a free radical-forming agent such as benzopinacol. The choice of initiator determines the course of the curing reaction to a significant extent. The combination of a cationic crosslinking agent with a co-catalyst results in a suitable reaction rate profile, characterized by a narrowly defined optimum reaction temperature at which the reaction proceeds promptly without a sluggish reaction taking place at lower temperatures such as room temperature. This is also a prerequisite for stability of the one-component system in storage at room temperature.

The casting compound may also contain a silicone-containing component D, which is a dispersion or emulsion of one or more silicones in an epoxy resin. Suitable silicones include silicone oils, silicone block copolymers or silicone particles. Silicone particles in the form of silicone resin particles or silicone elastomer particles having a particle diameter of 10 nm to 100 μm are preferred. The silicone particles may essentially have a chemically modified surface in the form of a polymer layer of PMMA, for example (known as core-shell particles); however, it has been found that untreated, and/or surface-functionalized silicone particles are more suitable for the object on which the present invention is based. Essentially all compounds having at least two epoxy functions may be used as the epoxy resin, either alone or in mixture with other compounds with and without an epoxy function. However, the use of one or more of the diepoxides (I) through (VI) mentioned above is particularly advantageous. Silicone-containing component D contains up to 10 wt % to 80 wt % silicone, preferably 40 wt %. The casting compound may contain up to 25 wt % silicone-containing component D, preferably up to 10 wt %.

The casting compound is processed to a molded part at an elevated temperature. The casting compound has such a low viscosity and such a high capillary effect when suitably heated that in casting it is possible to fill up even unfavorable geometric shapes, such as casting gaps having a diameter of <300 μm. At the same time, this permits very short cycle times. After casting, the casting compound is exposed to a temperature of 60° C. to 100° C. for 30 to 300 minutes or 120° C. for 10 to 100 minutes to induce gelling of the casting compound. Then it is exposed to a temperature of 140° C. to 220° C. for 10 to 90 minutes to cure the molded part. The processing time is thus much less than 50% of the time normally to be used in casting two-component product.

The following exemplary embodiments of casting compounds and/or their compositions (in wt %) and their resulting properties in the cured state are shown as examples below.

Compositions:

| Exemplary embodiment | 1 | 2 | 3 | 4 | 5 |
|---|---|---|---|---|---|
| Epoxy resin component A | 35.8 | 33.5 | 33.5 | 33.5 | 37.3 |
| Silicone | 2¹ | 3.8¹ | 3.8² | 3.8³ | 0 |
| Fused silica as filler B | 59.5 | 60.8 | 60.8 | 60.8 | 60.8 |
| Additives | 1.6 | 0.8 | 0.8 | 0.8 | 0.8 |
| Initiator C | 1 | 1.1 | 1.1 | 1.1 | 1.1 |

¹Silicone particles
²Silicone nanoparticles
³Silicone core-shell particles

The compositions given above yield the following profile of properties:

| | |
|---|---|
| viscosity at 60° C.: | 15,000 to 55,000 mPas |
| After curing: | |
| linear shrinkage: | 0.3% to 0.6% |
| glass transition temperature: | 160° C. to 185° C. |
| thermal expansion coefficient: | 30 × 10⁻⁶ 1/° C. to 37 × 10⁻⁶ 1/° C. |
| elongation at rupture: | 0.4% to 1.25% |

The casting compound is particularly suitable because of its thermal stability for casting components which are exposed to temperatures up to 240° C. at least temporarily. Thus, in particular power diodes having high conducting-state currents or corresponding module rectifiers may be protected effectively from ambient effects by this casting compound. Such diodes are used in generators for automotive engineering, among other applications.

What is claimed is:

1. A casting compound having a high thermal stability and that is stable in storage as a one-component system, comprising:
an epoxy resin component;
a filler containing silanized fused silica; and
an initiator.

2. The casting compound as recited in claim 1, further comprising:
a silanizing agent.

3. The casting compound as recited in claim 2, wherein:
the silanizing agent is a trialkoxysilane.

4. The casting compound as recited in claim 2, wherein:
the silanizing agent is an epoxysilane.

5. The casting compound as recited in claim 1, wherein:
the silanized fused silica has a particle size of 0.5 to 200 μm.

6. The casting compound as recited in claim 1, wherein:
the silanized fused silica is of at least two different particle size distributions.

7. The casting compound as recited in claim 1, wherein:
the filler is included according to 10 to 85 percent by weight.

8. The casting compound as recited in claim 7, wherein:
the filler is included according to 55 to 65 percent by weight.

9. The casting compound as recited in claim 1, wherein:
the epoxy resin component is an epoxy resin based on one of a cycloaliphatic diepoxide and triepoxide.

10. The casting compound as recited in claim 1, further comprising:
a silicone-containing component.

11. The casting compound as recited in claim 10, wherein:
the silicone-containing component is a dispersion of a silicone in an epoxy resin based on a diepoxide.

12. The casting compound as recited in claim 10, wherein:
the silicone-containing component contains silicone elastomer particles.

13. The casting compound as recited in claim 12, wherein:
the silicone elastomer particles have a particle diameter of 10 nm to 100 μm.

14. The casting compound as recited in claim 1, wherein:
the initiator includes a co-catalyst.

15. A method of producing a casting compound, comprising:
silanizing fused silica with a silanizing agent; and
mixing the silanized fused silica as a filler with at least one epoxy resin component and an initiator to form the casting compound.

16. The method of producing the casting compound as recited in claim 15, further comprising:
mixing the at least one epoxy resin component, the filler, and an initiator with the silanizing agent.

17. A method of using a casting compound having a high thermal stability and that is stable in storage as a one-component system, the casting compound including an epoxy resin component, a filler containing silanized fused silica, and an initiator, the method comprising:
producing a diode with the casting compound.

18. A method of using a casting compound having a high thermal stability and that is stable in storage as a one-component system, the casting compound including an epoxy resin component, a filler containing silanized fused silica, and an initiator, the method comprising:
producing a module rectifier with the casting compound.
